(19) United States
(12) Patent Application Publication
(10) Pub. No.: US 2023/0264054 A1
(43) Pub. Date: Aug. 24, 2023

(54) FIRE-FIGHTING DEVICE

(71) Applicants: Jacques PITOUX, DUBAI (AE); Aline BERTAGNE, DUBAI (AE); Alec BERTAGNE, DUBAI (AE); Pierrick DURET, DUBAI (AE); Patrice Queiras, DUBAI (AE); Bruno Jean Gilbert LIVERRGNE, DUBAI (AE); Youcef DJANEH, DUBAI (AE); Morgane RAVIER, DUBAI (AE); Robin TOURNOUX, DUBAI (AE); Jérôme LUPO, Moutiers (FR); Laurent RAVIER, Fos-sur-Mer (FR); René Alphone Joseph Marie DURET, Jard-sur-Mer (FR); Marie-Renée Blanche Michèle DURET, Jard-sur-Mer (FR); Baptiste Sylvain Charly GADROY, MIMIZAN (FR); Faustine LERAY, MIMIZAN (FR); Jean-François KWASEK, AUREILHAN (FR)

(72) Inventor: Jacques PITOUX, DUBAI (AE)

(21) Appl. No.: 17/914,728

(22) PCT Filed: Mar. 25, 2021
(86) PCT No.: PCT/EP2021/057793

§ 371 Date: Apr. 27, 2023

(30) Foreign Application Priority Data
Mar. 27, 2020 (FR) FR2003009

(51) Int. Cl. A62C 3/02; F42C 19/08

(52) U.S. Cl. CPC A62C 3/025; F42C 19/0838

(57) ABSTRACT

Disclosed is a fire-fighting device, which includes a casing that delimits an inner cavity in which at least one dispersible fire-extinguishing agent is deposited, and pyrotechnics suitable for generating an explosion causing the casing to rupture and the fire-extinguishing agent to be dispersed. The pyrotechnics include at least one explosive charge, generating the explosion, and a detonator for triggering the explosion of the at least one explosive charge. The detonator includes an ignition device designed to trigger, when in an active state, the explosion of the at least one explosive charge, and an impact sensor designed to detect a mechanical impact received by the device and to bring the ignition device to the active state upon detection of the mechanical impact.

This application is the U.S. national phase of International Application No. PCT/EP2021/057793 filed Mar. 25, 2021 which designated the U.S. and claims priority to FR 2003009 filed Mar. 27, 2020, the entire contents of each of which are hereby incorporated by reference.

### BACKGROUND OF THE INVENTION

### Field of the Invention

The present invention generally relates to the field of fire fighting.

More particularly, it relates to the fire-fighting devices.

### Description of the Related Art

Whether in urban areas or in the wilderness, fires may cause significant human and material damages.

Generally, the human resources and equipment mobilized to fight against fires are adapted to their extent and to the site concerned.

A wide range of fire-fighting equipment is known, from simple foam or powder extinguisher to fire tankers and water bombers.

As described in document U.S. Pat. No. 6,786,382, a fire-fighting item is also known, which consists of a destructible container in the form of a sphere made of foam of rigid, low-density plastic material (for example, expanded polystyrene foam), of about ten centimeters to a few tens of centimeters in diameter, and which encloses a dispersible chemical product active against fire and a pyrotechnic detonator associated with a fuse.

In an “active” approach, it would be interesting to throw this fighting item directly into the fire, in such a way that the fuse thereof is ignited, ensuring the detonator activation, followed by the container destruction and the dispersion of the dispersible chemical product.

But, with time, such fighting items are unfortunately not fully effective for this approach, in particular depending on the location of the fire to be extinguished or on the site configuration.

It is indeed advisable that these fighting items remain a sufficient time in the fire (at least a few seconds) so that the fuse thereof is ignited and the detonator activated, ensuring the release of the dispersible chemical product.

Now, due to its inertia and trajectory, the fighting item is likely to exit from the fire before its fuse has had time to catch fire.

This is for example the case when the fighting item bounces out of the fire, when the ground is sloping or when the throwing speed was not adapted.

There thus exists a need to improve these fighting items to allow such an “active” approach.

### SUMMARY OF THE INVENTION

The present invention thus proposes a fire-fighting device improving/enhancing the fighting items in accordance in particular with document U.S. Pat. No. 6,786,382, which is particularly adapted to such an active approach (projected/thrown directly into the fire).

More particularly, it is proposed according to the invention a fire-fighting device that comprises:
a casing (also named shell or envelope), preferably frangible, which delimits an inner cavity in which at least one dispersible fire-extinguishing agent is deposited, and
pyrotechnic means suitable for generating an explosion causing said casing to rupture and said extinguishing agent to be dispersed.

The pyrotechnic means comprise:
at least one explosive charge, generating said explosion, and
detonator means for triggering said explosion of said at least one explosive charge.

According to the invention, said detonator means comprise:
an ignition device designed to trigger, when in an active state when in an active state, said explosion of the at least one explosive charge, and
an impact sensor designed to detect a mechanical impact received by said device and to bring said ignition device to said active state upon detection of said mechanical impact.

Therefore, in practice, the device according to the invention can be projected directly into the fire and can release its fire-extinguishing agent within this fire (or even in the immediate vicinity thereof or above it) thanks to its impact triggering system.

Indeed, as soon as the projected device hurts a surface (advantageously within this fire), its impact sensor detects a mechanical impact and brings (instantaneously, or even with a time delay or latency) the ignition device to its active state.

The ignition device, in its active state, causes (instantaneously) said at least one explosive charge to explode and, as a corollary, said casing to rupture and said fire-extinguishing agent to be dispersed.

Such a device according to the invention therefore no longer needs fire exposure time, as required with the fighting items known from the prior art.

Generally, said impact sensor according to the invention advantageously comprises a mobile portion that is able to move between two positions:
an initial position, in which the ignition device is in an inactive state, and
a final position, in which the ignition device is in an active state,

said mobile portion cooperating with:
means for elastic return towards said final position, and
holding means, designed to hold said mobile portion in said initial position and to release said mobile portion upon said mechanical impact.

According to a preferred embodiment, the holding means comprise a metal part, for example a ball, pinched between the mobile portion and a support portion.

Upon the mechanical impact, the metal part is then intended to be extracted (ejected) from its location/initial state (advantageously, due to its inertia).

The moving of this metal part then releases the mobile portion, which is operated from its initial position to its final position, under the effect of the elastic return means.

Still generally, and according to a particular embodiment, the ignition device is an electric ignition device, also called igniter. The impact sensor consists of an electric module connected to said electric ignition device.

Preferably, the electric module comprises:
an electric power source,
a switch that integrates said mobile portion,

said mobile portion being able to move between the two positions:
the initial position, in which the switch is in an open state, and
the final position, in which the switch is in a closed state.

The electric ignition device advantageously comprises a primer head that cooperates with said at least one explosive charge:
indirectly, through a pyrotechnic fuse that connects said primer head and said at least one explosive charge, or
directly, within said at least one explosive charge.

Preferably, the detonator means comprise state indicator means, in particular adapted to indicate an activated state of the impact sensor (chosen for example among sound, visual means, etc.).

According to another particular embodiment, the ignition device consists of a mechanical ignition device.

In this case, the mechanical ignition device advantageously comprises:
a firing pin, forming said mobile portion,
a primer, intended to be struck by said firing pin when the latter switches from said initial position to said final position, and
at least one fuse, intended to be ignited by said primer and that extends up to said at least one explosive charge.

And, as the case may be, the holding means are preferably implanted between the firing pin and the primer.

Other non-limiting and advantageous features of the product according to the invention, taken individually or according to all the technically possible combinations, are the following:
the impact sensor is external to said inner cavity, at the surface of the casing or remote from the casing, or integrated into the inner cavity; the impact sensor is advantageously placed on the surface of said casing, using removable fastening means, for example adhesive tapes or structures driving into said casing; preferably, an added pad, forming a “target marking” is used and added to facilitate the positioning of the primer head facing the pyrotechnic fuse;
the impact sensor is protected within a shell that advantageously has a shape chosen among a spherical cap and a sphere;
the casing consists of a spherical casing, for example made of at least one plastic material;
said detonator means comprise primer means intended to be controlled in such a way as to allow the switching of said ignition device to said active state upon detection of said mechanical impact.

The present invention also relates to a fire-fighting system, said system comprising:
at least one device according to the invention, and
at least one flying machine, advantageously a drone, comprising at least one dropping module, adapted to receive said at least one device and to drop said at least one device above a fire.

The present invention also relates to a fire-fighting method, said method comprising a step of dropping at least one device according to the invention, advantageously from a flying machine, preferably a drone, in such a way that said at least one explosive charge is triggered when said device hurts a surface after its dropping.

The present invention also relates to the detonator means for a device according to the invention, comprising:
an ignition device designed to trigger, when in an active state, said explosion of the at least one explosive charge, and
an impact sensor designed to detect a mechanical impact received by said device and to bring said ignition device to said active state upon detection of said mechanical impact.

Of course, the different features, alternatives and embodiments of the invention can be associated with each other according to various combinations, insofar as they are not mutually incompatible or exclusive.

### BRIEF DESCRIPTION OF THE DRAWINGS

Moreover, various other features of the invention will be apparent from the appended description made with reference to the drawings that illustrate non-limiting embodiments of the invention, and wherein:

FIG. 1 is a schematic cross-sectional view of a fire-fighting device according to the invention comprising electric detonator means that are equipped with an impact sensor formed by an external electric module, fastened to the casing, and an internal electric ignition device;

FIG. 2 is a schematic perspective view of the embodiment according to FIG. 1, in which the impact sensor is separated from the casing;

FIG. 3 is a schematic view that illustrates the components of an impact sensor according to FIG. 1;

FIG. 4 is a schematic exploded view of the impact sensor according to FIG. 3;

FIG. 5 is a schematic cross-sectional view that illustrates an alternative embodiment for the electric detonator means according to FIG. 1;

FIG. 6 is a schematic isolated view of the electric detonator means according to FIG. 5;

FIG. 7 is the electric diagram of the electric detonator means according to FIGS. 1 to 6;

FIG. 8 is a schematic and partially exploded view of another alternative of the fire-fighting device, in which the electric detonator means are equipped with an external electric ignition device;

FIG. 9 is a schematic, partial and enlarged view of the fire-fighting device according to FIG. 8, showing the assembly between the fuse and the electric ignition device;

FIG. 10 is also a schematic view of an alternative of the fire-fighting device in which the electric detonator means are gathered inside the casing;

FIG. 11 is a schematic view that illustrates here the components of the mechanical detonator means;

FIG. 12 is a schematic cross-sectional view that illustrates the detonator means according to FIG. 11, placed on a casing (partially shown);

FIG. 13 is a schematic perspective view of the mechanical detonator means according to FIG. 11;

FIG. 14 is a schematic cross-sectional view that illustrates the detonator means according to FIG. 11, after the primer means have been removed;

FIG. 15 is a cross-sectional and partial view of an alternative embodiment for the assembly of the detonator means on a casing;

FIG. 16 is a schematic perspective view of the detonator means according to FIG. 15;

FIG. 17 is a schematic cross-sectional view, with two detail views, that shows a device whose external impact sensor is located remote from the casing;

FIG. 18 is a schematic perspective view of a fire-fighting system comprising at least one device according to the invention (in a detail view) and a flying machine of the drone type;

FIG. 19 is a schematic exploded view illustrating a variant of the impact sensor according to FIG. 8 or 9, surface mounted, having a primer head in “indirect” arrangement;

FIG. 20 is a schematic view, with a partial cross-section, of the impact sensor according to FIG. 19;

FIG. 21 is a schematic and partial view that illustrates an alternative of the fire-fighting device in which the electric detonator means are partially gathered inside the casing;

FIG. 22 is a schematic and partial view of the flying machine of the drone type according to FIG. 18, showing activation means designed to control the primer means equipping the device according to the invention;

FIG. 23 is a schematic and partial view of the flying machine of the drone type according to FIG. 18, showing an embodiment of its dropping module.

### DESCRIPTION OF THE PREFERRED EMBODIMENTS

It is to be noted that, in these figures, the structural and/or functional elements common to the different alternatives can have the same references.

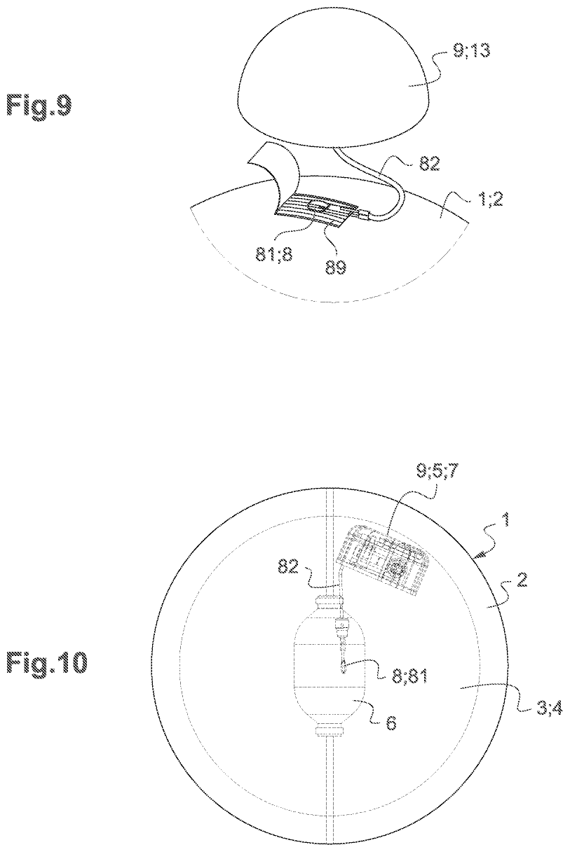

FIGS. 1 to 17 and 19 to 21 illustrate fire-fighting devices according to the invention.

Generally, the device 1 comprises:
a casing 2 that delimits an inner cavity 3 in which at least one dispersible fire-extinguishing agent 4 is deposited, and
pyrotechnic means 5 suitable for generating an explosion causing said casing 2 to rupture and said fire-extinguishing agent 4 to be dispersed.

The casing 2 thus advantageously consists of a frangible casing, also said “destructible”, adapted to be degraded by the explosion generated by the pyrotechnic means 5 while being able to resist to a mechanical impact described hereinafter.

This casing 2 here advantageously has the shape of a sphere (spherical shape).

This casing 2 is advantageously made of a plastic material, preferably rigid and low density, for example of the foam type, for example expanded polystyrene foam.

This casing 2 is advantageously enveloped in a plastic protective film.

This casing 2 advantageously has an outer diameter of about ten centimeters, or a few tens of centimeters.

Said at least one fire-extinguishing agent 4 preferably consists of a dispersible chemical product, advantageously a powder, active against fire.

Said at least one fire-extinguishing agent 4 is advantageously chosen among the fire-extinguishing powders that are essentially composed of non-toxic inorganic salts, mixed with water-repellent and anti-caking agents, as well as various additives (stearates, silicones, starch, inert minerals, etc.) to facilitate the flowing thereof.

Such powders may be based on sodium or potassium bicarbonate, or ammonium phosphate and/or sulphate (preferably ammonium phosphate).

The pyrotechnic means 5 comprise:
at least one explosive charge 6 (also called “pyrotechnic charge”), generating the explosion adapted to cause said casing 2 to rupture and said fire-extinguishing agent 4 to be dispersed, and
detonating means 7 for triggering the explosion of said at least one explosive charge 6.

Said at least one explosive charge 6 is advantageously implanted within the inner cavity 3, still preferably at the center of the latter.

Said at least one explosive charge 6 is advantageously embedded into at least one fire-extinguishing agent 4. In other words, said at least one explosive charge 6 is advantageously surrounded (or enveloped) by said at least one fire-extinguishing agent 4.

Said at least one explosive charge 6 is for example chosen among the black powders for fireworks (advantageously, deflagrating mixtures of sulphur, potassium nitrate (saltpeter) and charcoal), in particular among the bursting charges.

Said at least one explosive charge 6 is advantageously contained in a casing that may be made of various materials (papier, fabric, plastic, etc.)

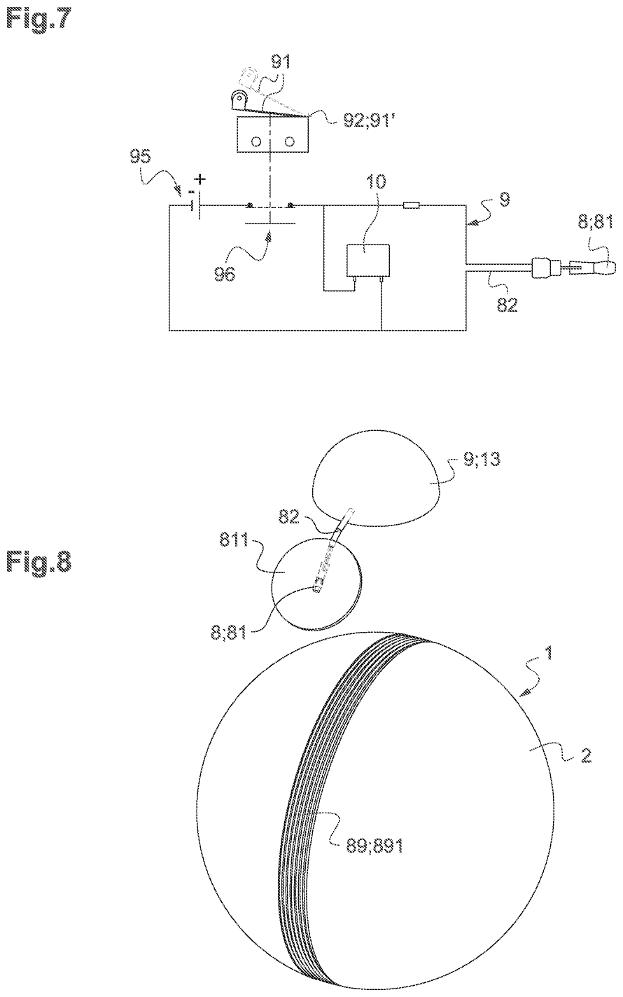

The detonator means 7, here forming an impact triggering system, comprise:
an ignition device 8 designed to trigger, when in an active state, said explosion of the at least one explosive charge 6,
an impact sensor 9 designed to bring this ignition device 8 to said active state upon detection of a mechanical impact,
preferably, state indicator means 10 (illustrated in FIGS. 7, 8, 19 to 21) that are in particular adapted to indicate/signal an activated state of the impact sensor 9,
preferably, primer means 11 intended to be controlled so as to prevent/allow the switching of the ignition device 8 in the active state upon detection of the mechanical impact by the impact sensor 9.

The ignition device 8 advantageously consists of means adapted to give birth to the combustion of said at least one explosive charge 6.

Such an ignition device 8 is advantageously chosen among the pyrotechnic detonators. It advantageously consists, as described hereinafter in relation with the various figures, of an electric ignition device or a mechanical ignition device.

Such an ignition device 8 thus has two states:
an initial and inert inactive state that does not trigger said explosion of said at least one explosive charge 6, and
a final active state, adapted to trigger the explosion of said at least one explosive charge 6.

This ignition device 8 can advantageously have two main arrangements with respect to said at least one explosive charge 6:
a “direct” arrangement (in particular FIG. 1), in which the ignition device 8 is positioned directly within said at least one explosive charge 6, or
an “indirect” arrangement (in particular, FIG. 8, 9, 19 or 20), in which the ignition device 8 is connected to said at least one explosive charge 6 via a pyrotechnic fuse 89.

The above-mentioned pyrotechnic fuse 89 then extends advantageously from said at least one explosive charge 6 and arrives at the outer surface of the casing 2.

This pyrotechnic fuse 89 can comprise an annular section 891 (visible in FIG. 8), which extends over the circumference of the outer surface of the casing 2 and in a transverse plane of the casing 2.

Such a pyrotechnic fuse 89 can be interesting to consider, in addition to the active use (projected on a target surface), a passive use of the device 1, that would come into contact with a fire.

Moreover, the impact sensor 9 is designed in such a way as, on the one hand, to detect a mechanical impact received by said device 1 and, on the other hand, to bring the above-mentioned ignition device 8 to said active state upon detection of said mechanical impact.

The term “mechanical impact” advantageously includes the very high amplitude accelerations resulting from the impact/collision of the device 1 on a receiving surface or target surface. Such a mechanical impact also corresponds to a discontinuity of speed of the device 1 in motion.

By way of non-limiting example, such a mechanical impact corresponds to the impact, on a rigid receiving surface, of the device 1 that is dropped from a falling height of at least 0.5 m (or even at least 1 m, or even at least 1.5 m).

The impact sensor 9 has advantageously two states:
an initial, rest state, in which the ignition device 8 also remains in its inactive state, and
a final, activated state, in which this impact sensor 9 controls the ignition device 8 to its active state adapted to trigger the explosion of said at least one explosive charge 6.

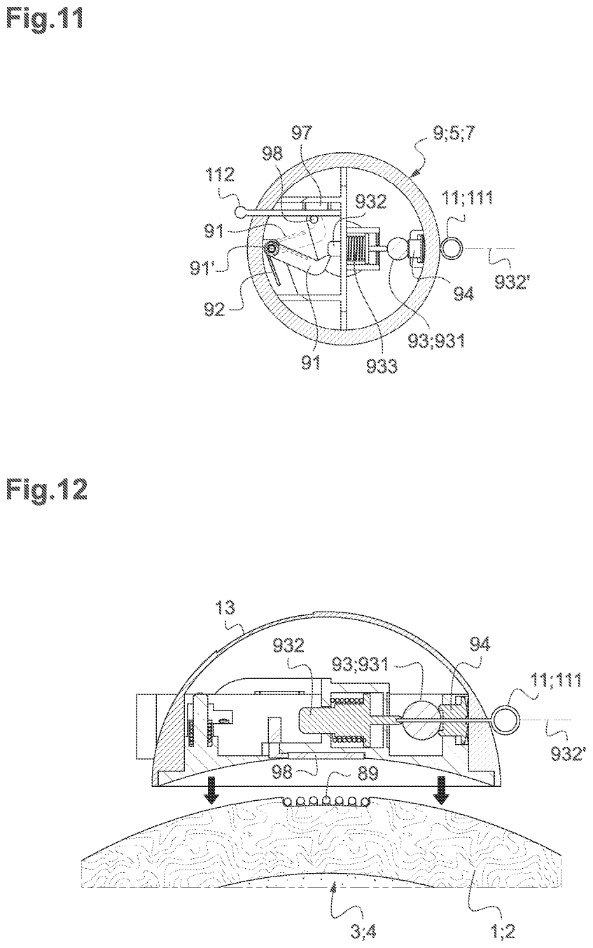

For that purpose, as illustrated for example in FIGS. 7 and 11, these states of the impact sensor 9 are advantageously obtained by the motions of a mobile portion 91.

The impact sensor 9 thus advantageously comprises a mobile portion 91 that is able to move between two positions:
an initial position (continuous lines in FIGS. 7, 11, 20 and 21), corresponding to the rest state of the impact sensor 9, in which the ignition device 8 is in its inactive state, and
a final position (discontinuous lines in FIGS. 7 and 11), corresponding to the activated state of the impact sensor 9, in which the ignition device 8 is driven to its active state.

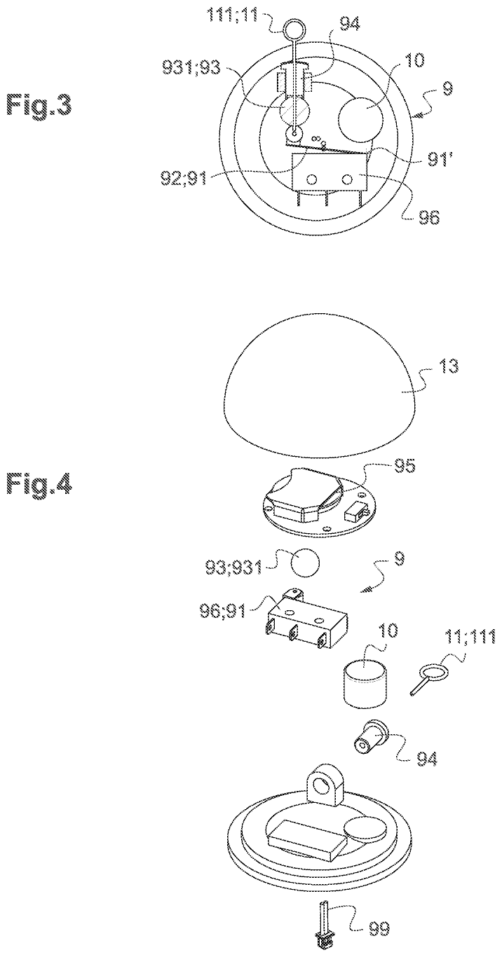

For that purpose, this mobile portion 91 has at least one part with one degree of freedom, advantageously a degree of freedom in rotation about a rotation axis 91′ (FIGS. 3, 7, 11) or a degree of freedom in translation.

For its implementation, the mobile portion 91 advantageously cooperates with:
elastic return means 92 for elastic return towards the final position, and
holding means 93, designed to hold the mobile portion 91 in its initial position and to release the mobile portion 91 upon said mechanical impact.

The elastic return means 92 advantageously consist of mechanical means, for example spring means, designed to tend to move the mobile portion 91 from its initial position to its final position.

The holding means 93 are advantageously intended to be degraded or deformed upon the mechanical impact.

The holding means 93 here comprise at least one metal part 931, for example a metal ball 931, which is intended to be extracted (ejected) from its location/initial state due to its inertia, when the impact sensor 9 is subjected to an impact/collision with a receiving surface.

As mentioned hereinabove, the metal part 931 is intended to be extracted (ejected) from its location/initial state upon an impact, on a rigid receiving surface, of the device 1 that is dropped from a falling height of at least 0.5 m (or even at least 1 m, or even at least 1.5 m).

Herein, the metal part 931 is advantageously pinched (directly or indirectly) between the mobile portion 91, in initial position, and a support portion 94.

Upon the mechanical impact, the moving of said at least one metal part 931 then releases the mobile portion 91, which is operated from its initial position to its final position, under the effect of the elastic return means 92.

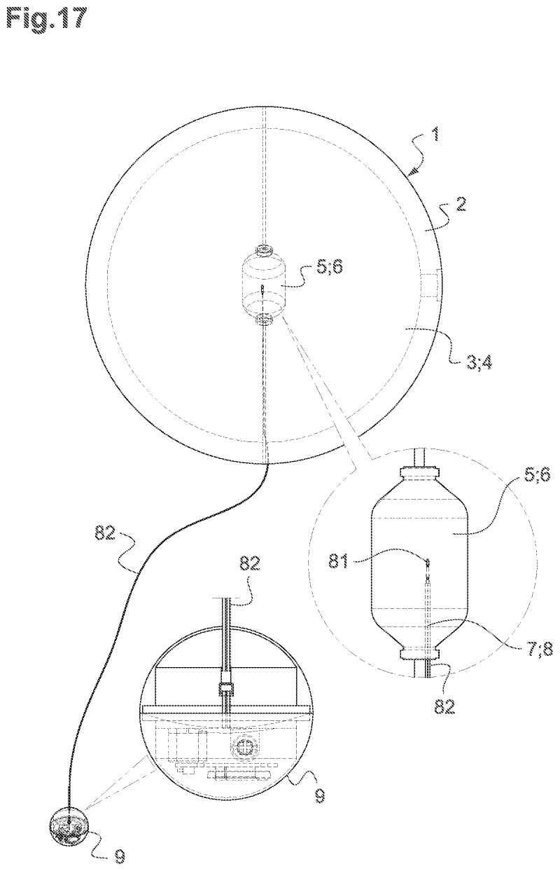

Generally, the impact sensor 9 (or even all or part of the ignition device 8) can advantageously have different locations in this device 1:
the impact sensor 9 may be external to said inner cavity 3, for example either at the surface of the casing 2, also said “surface mounted” (for example according to FIG. 1), or remote from the casing 2 (FIG. 17), or
the impact sensor 9 may be integrated, integrally or partially, into the inner cavity 3 (see for example FIGS. 10 and 21).

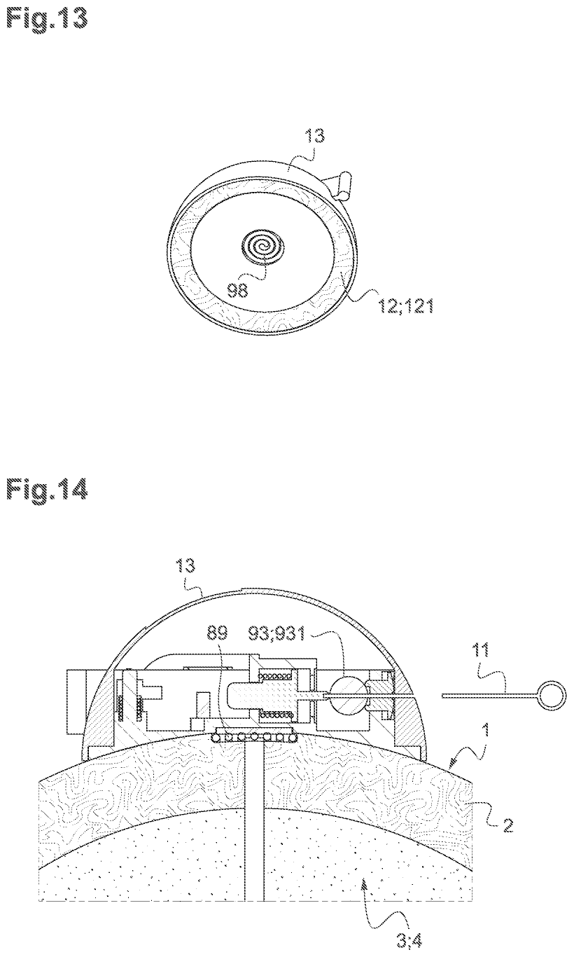

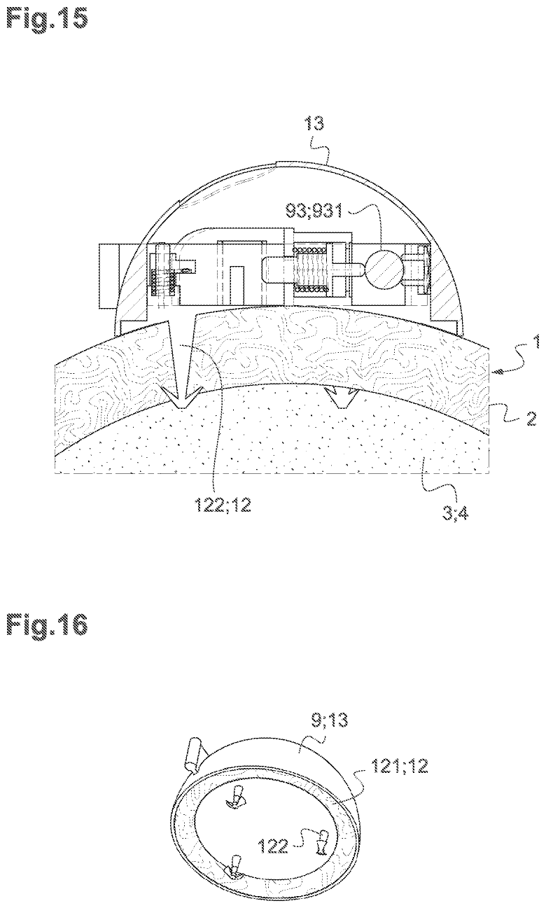

The impact sensor 9 can hence be added on the surface of said casing 2 (surface mounted), by means of removable fastening means 12, for example:
adhesive tapes 121 (FIG. 13), or
structures 122 driving into said casing 2 (FIGS. 15 and 16).

The driving structures 122 consist for example in rods that are ended by hooking fins.

The impact sensor 9, remote from the casing 2 (FIG. 17), has for interest that it can possibly touch the target surface before the casing 2 (dropping of the device 1 with the impact sensor 9 hung below it). In this case, the explosion will be generated high above the ground, still improving the dispersion of said at least one fire-extinguishing agent 4.

Still generally, the impact sensor 9 (or even all or part of the ignition device 8) is advantageously protected within a shell 13.

The shell 13 is for example made of a rigid plastic material, advantageously resistant to the above-mentioned mechanical impact.

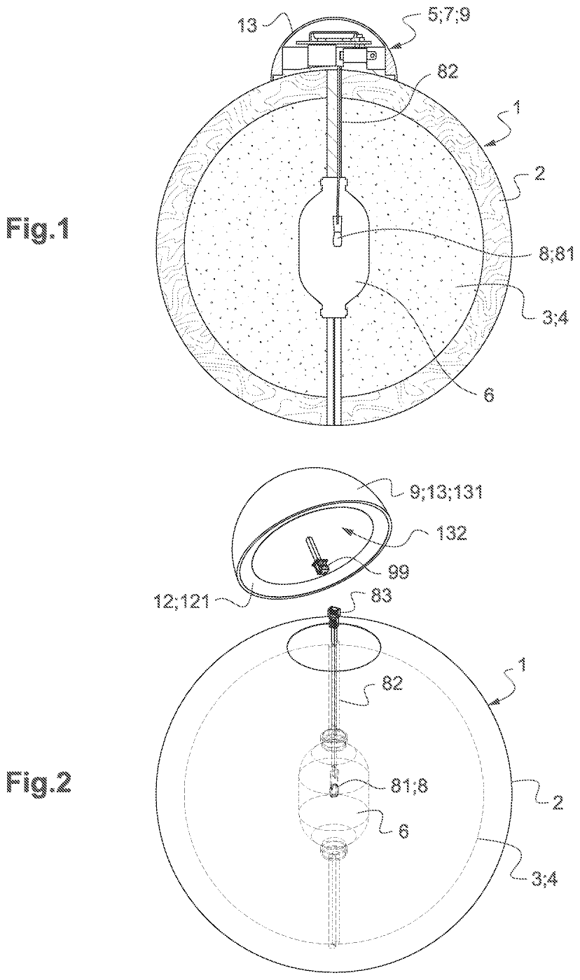

The shell 13 advantageously has a shape chosen among:
a spherical cap 131 (in particular, in FIGS. 1 and 2), especially for surface mounting on the casing 2 (with, advantageously, a concave lower face 132 to conform the casing 2), and
a sphere (in particular, FIG. 17), especially for a mounting remote from the casing 2.

The state indicator means 10 are hence adapted to indicate/signal an activated state of the impact sensor 9.

These state indicator means 10 are for example chosen among sound components (for example, buzzer or beeper) and/or light components (for example, an light-emitting diode or LED).

Such state indicator means 10 are in particular useful to avoid connecting an impact sensor 9, in activated state, with an ignition device 8 at the risk of involuntarily switching it to its active state.

As an alternative or complement, such state indicator means 10 aim to emit a signal immediately after an impact causing the switching of the impact sensor 9 to an activated state, with delay means (for example, electronic delay means) for the firing by the ignition device 8, in order to warn the surrounding persons about an imminent explosion causing the dispersion of said fire-extinguishing agent 4.

As another alternative or complement, the state indicator means 10 are intended to enable the location of the ignition device 8 after explosion, in order for example to recover the electric power source 95 (for example, an electric battery or an electric cell).

The primer means 11 are advantageously intended to cooperate with the mobile portion 91, potentially via the holding means 93, in such a way as to lock/hold this mobile portion 91 in its initial position in case of mechanical impact (before use, for example during transportation).

The primer means 11, for example of the pin type, are advantageously intended to be removed/degraded to allow the switching of the firing device 8 to the active state upon detection of the mechanical impact.

Preferably, these primer means 11 (provided with an external gripping portion) are accessible through the shell 13 (advantageously, at the spherical cap 131), for the removal/degradation thereof.

In practice and generally, the primer means 11 are, if need be, removed.

The device 1 may be moved (thrown, projected, dropped, sent, etc.) into the fire to be extinguished, in such a way as to land on a target surface.

Upon impact on the target surface, the impact sensor 9 is moved from its initial, rest state, to its final, activated state.

For that purpose, herein, the mobile portion 91 is here moved from its initial position (continuous line in FIGS. 7 and 11) to its final position (discontinuous lines in FIGS. 7 and 11).

This displacement is ensured here by the elastic return means 92, after the degradation of the holding means 93.

The impact sensor 9, in activated state, then controls the ignition device 8 (immediately or with a time delay) to its active state, which triggers the explosion of said at least one explosive charge 6 and the dispersion of said at least one fire-extinguishing agent 4.

This dispersion forms advantageously a cloud of fire-extinguishing agent 4 that allows a sudden three-dimensional fire-extinguishing effect.

Still according to the invention, the device 1 can take different embodiments.

A first family of embodiments according to the invention is illustrated in FIGS. 1 to 10 and 19 to 21.

In these first embodiments, the devices 1 each comprise an ignition device 8 that consists of an electric ignition device 8, also called igniter or electric igniter.

Conventionally, such an igniter 8 allows the instantaneous firing via a power line.

The igniter 8 generally consists of a short-circuited resistance, which is put in contact with a ball of pyrotechnic mixture.

As shown in FIG. 7, the igniter 8 is composed of a primer head 81 (for example, composed of mercury fulminate) welded to a double conductor 82. When the short-circuit is created at the double conductor 82, the primer head 81 is warmed by Joule effect and reaches its auto-ignition temperature.

The primer head 81 may have various arrangements, in order to cooperate with said at least one explosive charge 6:
a “direct” arrangement, in which the primer head 81 is directly housed within said at least one explosive charge 6 (FIG. 1, 5, 10 or 21), or
an “indirect” arrangement, in which the primer head 81 cooperates with the pyrotechnic fuse 89 that connects said primer head 81 and said at least one explosive charge 6 (FIGS. 8, 9, 19 and 20).

For the “direct” mounting, according to a first embodiment illustrated in FIG. 2, the double conductor 82 extends radially within the casing 2 and the cavity 3 in such a way as to be terminated by an external electrical connector 83 for its connection to the impact sensor 9 provided with a complementary electric connector 99.

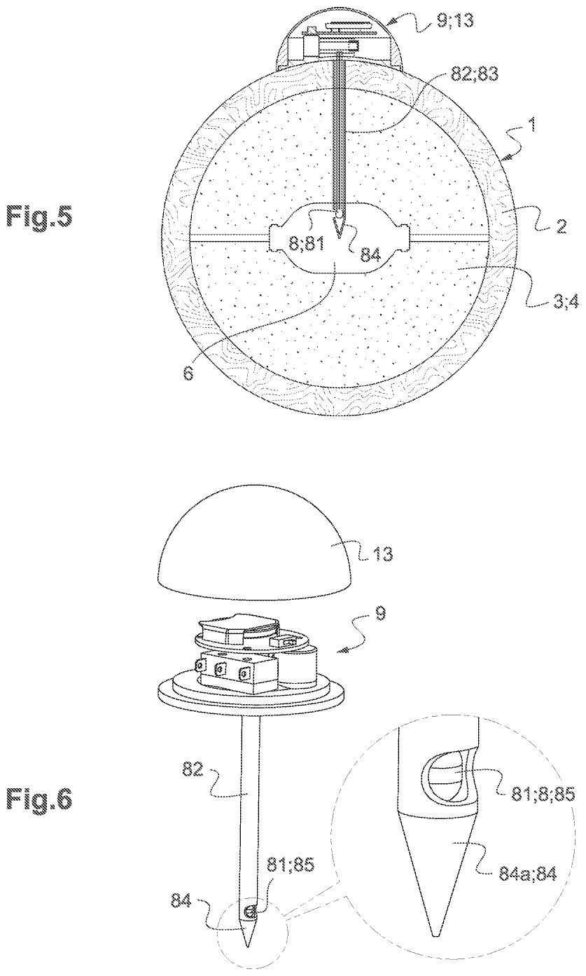

Still for the “direct” mounting, according to a second embodiment illustrated in FIGS. 5 and 6, the double conductor 82 extends radially within the casing 2 and the cavity 3, over the length of a tube 84 coming from the impact sensor 9.

This tube 84 includes a terminal end 84a, advantageously pointed to facilitate the introduction thereof, which is provided with a window 85 at which is located the primer head 81.

This terminal end 84a is intended to be housed, advantageously by being driven thereinto, within said at least one explosive charge 6. The flame generated by the primer head 81 is intended to exit through the window 85.

For the “indirect” mounting, the primer head 81 is advantageously attached to the annular section 891 of the pyrotechnic fuse 89.

The holding is for example obtained by means of an adhesive element 811 (par example an adhesive pad), as illustrated in FIG. 8 for example.

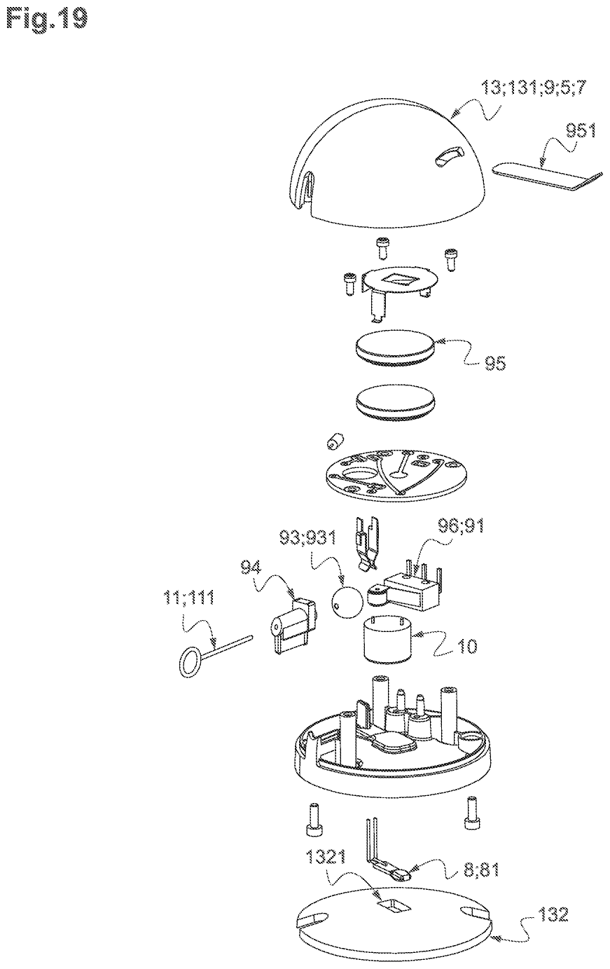

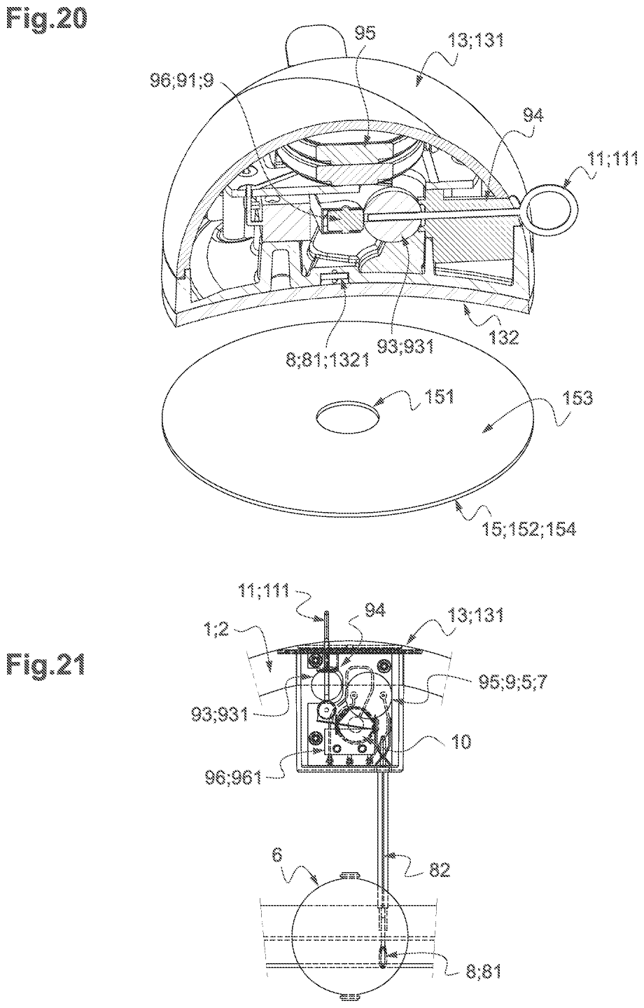

As an alternative, the concave lower face 132 comprises an aperture 1321 within which is positioned the primer head 81 (FIGS. 19 and 20). The primer head 81 is then advantageously attached to the annular section 891 of the pyrotechnic fuse 89. The holding of the primer head 81 on the pyrotechnic fuse 89 is advantageously obtained by the mounting of the firing device 8 on the casing 2.

In this case, an added pad 15, forming a “target marking”, is advantageously used and added to facilitate the positioning of the primer head 81 facing the pyrotechnic fuse 89.

This added pad 15 is advantageously intended to be placed between the casing 2 and the ignition device 8.

The added pad 15 is advantageously made in an adhesive plastic film.

The added pad 15, which is crown-shaped, advantageously has:
an inner edge 151, delimiting a through-hole, adapted to come facing the primer head 81 and the pyrotechnic fuse 89,
a lower face 152, advantageously adhesive, intended to conform the casing 2,
an upper face 153, intended to receive the concave lower face 132 of the shell 13, and
an outer edge 154.

For the positioning of the ignition device 8, the upper face 153 advantageously comprises a marking corresponding to the contour of the concave lower face 132 of the shell 13. As an alternative, the contour of the external edge 154 corresponds to the contour of the concave lower face 132 of the shell 13.

In practice, the added pad 15 is attached to the casing 2 in such a way that its inner edge 151 surrounds a part of the pyrotechnic fuse 89. Thereafter, the ignition device 8 is suitably positioned on the casing 2, thanks to the added pad 15 in presence; for that purpose, as the case may be, the adhesive element 811 equipping the concave lower face 132 of the shell 13 adheres to the upper face 153 of the added pad 15.

In these first embodiments, the impact sensor 9 advantageously consists of an electric module connected to the electric ignition device 8.

By “electric module”, it is meant equipment comprising an electrical circuit composed of an assembly of electric and/or electronic components.

Herein, as schematically shown in FIGS. 7, 19 and 20, the electric module 9 advantageously comprises:
an electric power source 95, for example an electric battery or an electric cell, advantageously associated with an insulating blade 951 intended to be removed to initiate the electric powering, and
a switch 96 that integrates the mobile portion 91.

This electric module 9 is intended to be electrically connected to the electric ignition device 8.

The mobile portion 91 is thus able to move between the two positions:
the initial position (continuous line), constrained, in which the switch 96 is in an open state and the ignition device 8 is not electrically powered by the electric power source 95, and
the final position (discontinuous line), at rest, in which the switch 96 is in a closed state and the ignition device 8 is electrically powered by the electric power source 95.

In an initial position or initial state, a metal part 931 (here a ball 931) is here pinched between, on the one hand, the mobile portion 91 of the switch 96, in initial position and in its open state and, on the other hand, the facing support portion 94.

As an alternative (not shown), instead of a mobile portion 91, the electric module 9 may comprise a sensor of the accelerometer type, preferably a non-servo accelerometer, and more precisely advantageously chosen among:
a piezoelectric detection accelerometer,
a piezoresistive detection accelerometer,
a capacitive detection accelerometer.

In this case, the electric module 9 also advantageously comprises:
the electric power source 95, for example an electric battery or an electric cell, and
control means (for example, a microcontroller) cooperating with the sensor of the accelerometer type.

The state indicator means 10 are advantageously adapted to emit a signal (sound, visual signal, etc.) when the impact sensor 9 is in an activated state.

This electric module 9 integrates for that purpose, for example, sound means (buzzer), visual means (LED), etc.

The state indicator means 10 are, as the case may be, adapted to emit a signal when the mobile portion 91 is in its final position (switch 96 in a closed state).

Such state indicator means 10 thus aim to prevent the assembly of an impact sensor 9 in an activated state with the ignition device 8, at the risk of causing an immediate switching to its active state.

As an alternative or complement, in the presence of a time delay, such state indicator means 10 can emit a signal after the impact, in order to warn the surrounding operators about the imminent explosion causing the dispersion of said fire-extinguishing agent 4.

As an alternative or complement, the state indicator means 10 can also be useful to locate and recover the ignition device 8 after the explosion.

The primer means 11 here consist of a pin 111 that passes, as the case may be, through the metal part 931, or even the support portion 94, for example in such a way as to extend between the support portion 94 and the mobile portion 91.

In this first family, different combinations (non-limiting) are therefore possible, as illustrated:
FIGS. 1 and 2, on the one hand, and FIGS. 5 and 6, on the other hand, envisage an impact sensor 9 external to said inner cavity 3, at the surface of the casing 2, with a primer head 81 (internal) housed directly within said at least one explosive charge 6,
FIGS. 8, 9, 19 and 20 envisage an impact sensor 9 external to said inner cavity 3, at the surface of the casing 2, with an external primer head 81 that cooperate with the pyrotechnic fuse 89,
FIGS. 10 and 21 envisage an impact sensor 9 internal to said inner cavity 3, with a primer head 81 (internal) housed directly within said at least one explosive charge 6,
FIG. 17 envisages an impact sensor 9 external to said inner cavity 3, remote from the casing 2, with a primer head 81 (internal) housed directly within said at least one explosive charge 6; the impact sensor 9 is secured to the casing 2, here via a flexible link, for example formed by the double conductor 82.

In particular, FIG. 10 envisages an impact sensor 9 that in fully internal to said inner cavity 3, with a primer head 81 (internal) housed directly within said at least one explosive charge 6.

FIG. 21 envisages an impact sensor 9 that is partially internal to said inner cavity 3 (a part of its shell 13 is accessible through the casing 2), with a primer head 81 (internal) housed directly within said at least one explosive charge 6.

According to FIG. 21, the shell 13 advantageously includes a spherical cap 131 that forms a continuous part of the casing 2 of the device 1 (the spherical cap 131 radius is identical to the casing 2 radius).

In this embodiment, the casing 2 advantageously comprises a through-hole adapted for the insertion (advantageously, with a clearance) of the impact sensor 9. This through-hole is thus advantageously closed by the added impact sensor 9.

The casing 2 advantageously comprises a second through-hole, in order to facilitate the filling of the casing 2 with the fire-extinguishing agent 4. This second through-hole is intended to be closed after having been filled, for example by means of a polystyrene plug.

For that purpose, the casing 2 advantageously comprises two semi-casings (or semi-shells or semi-spheres) identical to each other, each comprising a through-hole (advantageously at the apex thereof).

These two semi-casings are intended to be assembled with each other, to form together the casing 2 of the device 1.

In practice, in these first embodiments, upon percussion, the metal part 931 is, as the case may be, ejected from its initial location.

The mobile portion 91 is thus able to move from its initial position (continuous line), in which the switch 96 is in an open state, to its final position (discontinuous line), at rest, in which the switch 96 is in its closed state.

As an alternative and as the case may be, the mechanical impact is detected by the accelerometer.

The impact sensor 9, activated, then controls the ignition device 8 to its active state: a short-circuit is created at the double conductor 82, in such a way that the primer head 81 is warmed by Joule effect and reaches its auto-inflammation temperature.

The primer head 81 triggers the explosion of said at least one explosive charge 6 and the dispersion of said at least one fire-extinguishing agent 4:
directly, when the primer head 81 is directly housed within said at least one explosive charge 6 (FIG. 1, 5, 10 or 21), or
indirectly, when the primer head 81 cooperates with the pyrotechnic fuse 89 that connects said primer head 81 and said at least one explosive charge 6 (FIG. 8, 9, 19 or 20).

A second family of embodiments according to the invention is illustrated in FIGS. 11 to 14.

In these second embodiments, the devices 1 comprise an ignition device 8 that consists of a mechanical ignition device 8.

For example, as described in relation with FIG. 11, the mechanical ignition device 8 comprises:
a firing pin 91, forming the mobile portion 91,
a primer 97, intended to be struck by the firing pin 91 when the latter switches from said initial position to said final position (under the effect of the elastic return means 92), and
at least one fuse 98, intended to be ignited by the primer 97 and that extends up to said at least one explosive charge 6 (advantageously, via the above-mentioned pyrotechnic fuse 89).

The fuse 98 advantageously arrives under the ignition device 8, with a spiral portion that is intended to cover the above-mentioned pyrotechnic fuse 89. This particular shape of the fuse 98 aims to optimize the pyrotechnic fuse 89.

Preferably, herein, the holding means 93 are implanted between the firing pin 91 and the primer 97.

The holding means 93 here comprise:
the above-mentioned metal part 931, and
a mobile stop 932 cooperating with elastic return means 933.

The stop 932 is adapted, on the one hand, to pinch the metal part 931 with the support portion 94, and on the other hand, to hold the mobile portion 91 in its initial position.

The stop 932 can be moved between two limit positions, here in translation along a translation axis 932′, i.e.:
an extended position (FIG. 11), held by the metal part 931, in which said stop 932 is interposed on the path of the mobile portion 91 in order to hold the latter in its initial position, and
a retracted position, after ejection of the metal part 931 and under the action of the elastic return means 933, in which said stop 932 is away from the path of the mobile portion 91 (firing pin) to allow the switching thereof to the final position.

In the extended position, the metal part 931 is thus pinched between the stop 932 (in extended position) and the support portion 94.

The primer means 11 here comprise:
a pin 111 that passes through the metal part 931 in such a way as to extend between the support portion 94 and the mobile stop 932, and
a plate 112, forming a screen placed in front of the primer 97 and positioned on the path of the mobile portion 91.

Here again, different arrangements (non-limiting) are possible.

FIGS. 11 to 16 envisage an impact sensor 9 external to said inner cavity 3, at the surface of the casing 2 cooperating with the pyrotechnic fuse 89.

As an alternative and in a non-limiting manner, the impact sensor 9 could also be internal to said internal cavity 3.

In practice, in these second embodiments, upon percussion, the metal part 931 is ejected from its initial location.

After removal of the metal part 931 and under the action of the elastic return means 933, the stop 932 is operated to its retracted position, in such a way as to be away from the stroke of the mobile portion 91 to allow the switching thereof to the final position.

The mobile portion 91 is thus able to move from its initial position (continuous line) to its final position (discontinuous line), at rest, in which it hurts the primer 97, which fires the fuse 98 causing the explosion of the explosive charge 6 (here via the pyrotechnic fuse 89).

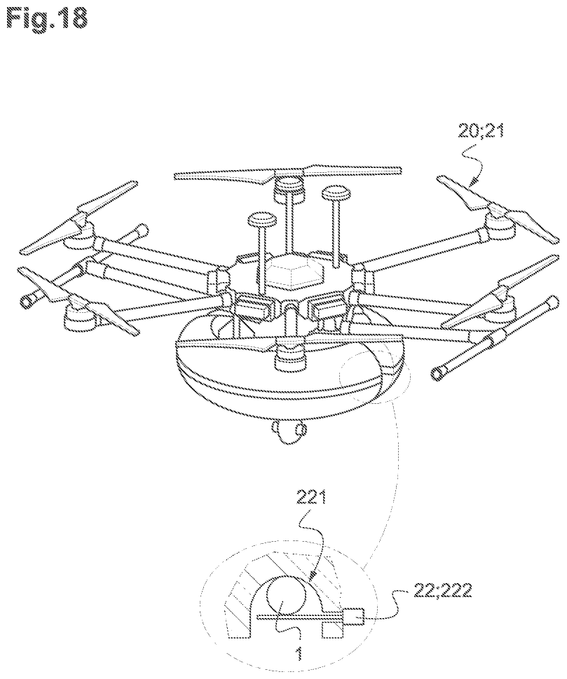

The device 1 according to the invention is advantageously implemented within a fire-fighting system 20 (FIGS. 18, 22 and 23).

Such a system 20 comprises:
at least one device 1 according to the invention, and
at least one flying machine 21, advantageously a drone.

Said at least one flying machine 21 comprises at least one dropping module 22 to is adapted to receive at least one device 1 according to the invention and to drop said at least one device 1 above a fire.

The dropping module 22 advantageously has for that purpose, two positions:
a transport position, closed, for the storage of at least one device 1, and
a dropping position, open, for the dropping of at least one device 1.

Such a dropping module 22 comprises for example a housing 221 associated with mobile shutting means 222 (FIGS. 18 and 23).

The control between these two positions is for example done remotely by an operator.

According to an embodiment illustrated in FIG. 23, the mobile shutting means 222 comprise for example a shutting element 2221 (for example a strap) that passes through the lower opening of the housing 211 in such a way as to hold the device 1 in transport position.

This shutting element 2221 cooperates with an actuator 2222 (for example a servomotor) for operating the shutting element 2221 between the transport position (FIG. 23) and the dropping position (not shown).

Herein, the strap 2221 has:
a fixed end, secured to the frame of the flying machine 21, and
a mobile end cooperating with the actuator 2222.

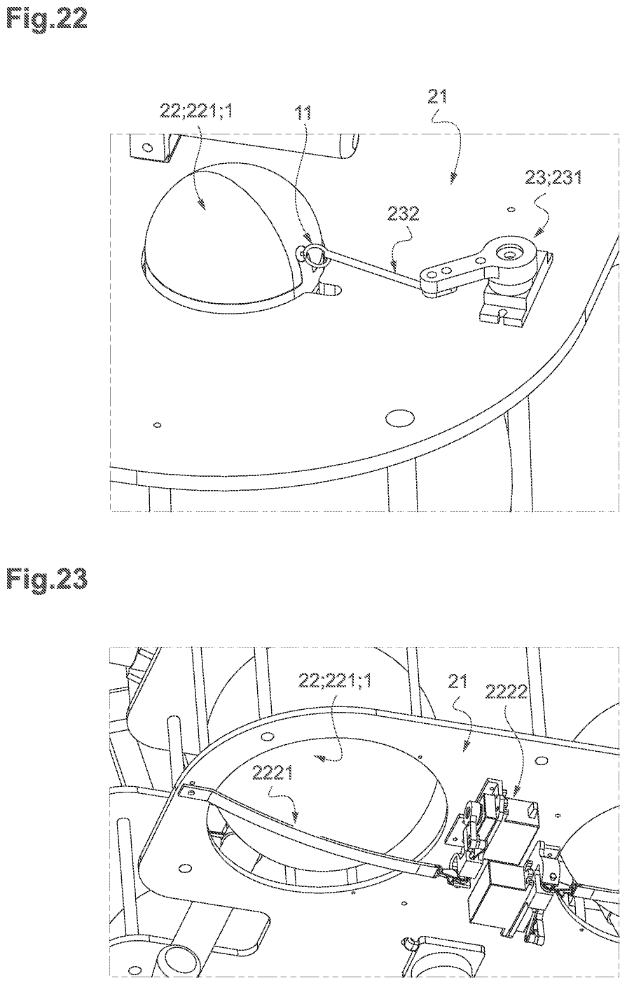

According to an advantageous embodiment, said at least one flying machine 21 also includes activation means 23 provided to control the primer means 11 equipping the device 1 according to the invention before the dropping of the latter (FIG. 22).

The activation means 23 comprise for example an actuator 231 (for example, a servomotor) that is connected to the primer means 11 via a linking element 232.

The activation means 23 are adapted to operate the primer means 11 to a removed/degraded state, advantageously just before the control of the dropping module 22, to allow the switching of the ignition device 8 to the active state upon detection of the mechanical impact.

In practice, such a system 20 allows the implementation of the fire-fighting method.

This method comprises a step of dropping at least one device 1 according to the invention, from the flying machine 21, which is advantageously positioned above the fire to be extinguished.

For that purpose, at least one dropping module 22 is controlled from its transport position to its dropping position.

As developed hereinabove, when the device 1 hurts a surface after having been dropped, said at least one explosive charge 6 is (immediately) triggered, which causes the (immediate) dispersion of said at least one fire-extinguishing agent 4.

Of course, various other modifications can be made to the invention within the framework of the appended claims.

1. A fire-fighting device,
said device comprising:
a casing that delimits an inner cavity in which at least one dispersible fire-extinguishing agent is deposited, and
pyrotechnic means suitable for generating an explosion causing said casing to rupture and said fire-extinguishing agent to be dispersed,
said pyrotechnic means comprising:
at least one explosive charge, generating said explosion, and
detonating means for triggering said explosion of said at least one explosive charge,
wherein said detonating means comprise:
an ignition device designed to trigger, when in an active state, said explosion of said at least one explosive charge, and
an impact sensor designed to detect a mechanical impact received by said device and to bring said ignition device to said active state upon detection of said mechanical impact.

2. The fire-fighting device according to claim 1, wherein said impact sensor comprises a mobile portion that is able to move between two positions:
an initial position, in which the ignition device is in an inactive state, and
a final position, in which the ignition device is in an active state,
said mobile portion cooperating with:
means for elastic return to said final position, and
holding means, designed to hold said mobile portion in said initial position and to release said mobile portion upon said mechanical impact.

3. The fire-fighting device according to claim 2, wherein the holding means comprise a metal part ball, pinched between said mobile portion and a support portion.

4. The fire-fighting device according to claim 1, wherein the ignition device consists of an electric ignition device, also called igniter, and
wherein the impact sensor consists of an electric module connected to said electric ignition device.

5. The fire-fighting device according to claim 4, wherein the electric module comprises:
an electric power source,
a switch that integrates said mobile portion,
wherein said mobile portion is able to move between the two positions:
the initial position, in which the switch is in an open state, and
the final position, in which the switch is in a closed state.

6. The fire-fighting device according to claim 1, wherein the electric ignition device includes a primer head that cooperates with said at least one explosive charge:
indirectly, through a pyrotechnic fuse that connects said primer head and said at least one explosive charge, or
directly, within said at least one explosive charge.

7. The fire-fighting device according to claim 1, wherein the detonating means comprise state indicator means.

8. The fire-fighting device according to claim 1, wherein the ignition device consists of a mechanical ignition device.

9. The fire-fighting device according to claim 8, wherein the mechanical ignition module comprises:
a firing pin, forming said mobile portion-,
a primer, intended to be struck by said firing pin when said firing pin switches from said initial position to said final position, and
at least one fuse, intended to be ignited by said primer, and that extends to said at least one explosive charge.

10. The fire-fighting device according to claim 1, wherein the impact sensor is:
external to said inner cavity, at the surface of the casing or remote from the casing, or
integrated in the inner cavity.

11. The fire-fighting device according to claim 1, wherein said detonating means comprise primer means-intended to be controlled in such a way as to allow the switching of said ignition device to said active state upon detection of said mechanical impact.

12. A fire-fighting system, said system comprising:
at least one device according to claim 1, and
at least one flying machine, including at least one dropping module, adapted to receive said at least one device and to drop said at least one device above a fire.

13. A fire-fighting method, said method comprising a step of dropping at least one device according to claim 1, in such a way that said at least one explosive charge is triggered when said device hurts a surface after having been dropped.

14. Detonating means for a device according to claim 1, comprising:
an ignition device designed to trigger, when in an active state, said explosion of said at least one explosive charge, and
an impact sensor designed to detect a mechanical impact received by said device and to bring said ignition device to said active state upon detection of said mechanical impact.

15. The fire-fighting device according to claim 2, wherein the ignition device consists of an electric ignition device, also called igniter, and
wherein the impact sensor consists of an electric module connected to said electric ignition device.

16. The fire-fighting device according to claim 5, wherein the electric ignition device includes a primer head that cooperates with said at least one explosive charge:
indirectly, through a pyrotechnic fuse that connects said primer head and said at least one explosive charge, or
directly, within said at least one explosive charge.

17. The fire-fighting device according to claim 5, wherein the detonating means comprise state indicator means.

18. The fire-fighting device according to claim 6, wherein the detonating means comprise state indicator means.

19. The fire-fighting device according to claim 2, wherein the ignition device consists of a mechanical ignition device.

20. The fire-fighting device according to claim 3, wherein the ignition device consists of a mechanical ignition device.
